(19) United States
(12) Patent Application Publication
(10) Pub. No.: US 2026/0276827 A1
(43) Pub. Date: Sep. 17, 2026

(54) CLEAN ROOM FLOOR OPENING DETECTION

(71) Applicant: Tokyo Electron Limited, Tokyo (JP)

(72) Inventors: Hikaru AKADA, Kumamoto (JP); Takayuki OGAMI, Kumamoto (JP)

(21) Appl. No.: 19/676,804

(22) Filed: May 14, 2026

Related U.S. Application Data
(63) Continuation of application No. PCT/JP2024/039964, filed on Nov. 11, 2024.

(30) Foreign Application Priority Data
Nov. 22, 2023 (JP) 2023-197897

(51) Int. Cl. G01S 17/89; G01B 11/06

(52) U.S. Cl. CPC G01S 17/89; G01B 11/0608

(57) ABSTRACT

A method include: generating three-dimensional data of the interior of the cleanroom from a ranging result using electromagnetic waves; comparing a height of each part of the interior of the cleanroom indicated by the three-dimensional data, with a predetermined reference height; and detecting an opening in the floor from which a floor tile has been removed, based on a result of the comparing.

### CROSS-REFERENCE TO RELATED APPLICATIONS

This application is a continuation application of PCT Application No. PCT/JP2024/039964, filed on November 11, 2024, which claims the benefit of priority from Japanese Patent Application No. 2023-197897, filed on November 22, 2023. The entire contents of the above listed PCT and priority applications are incorporated herein by reference.

### BACKGROUND

### Field

The present disclosure relates to a monitoring method, a monitoring apparatus, and a computer storage medium.

### Description of the Related Art

Japanese Patent No. 6018821 discloses a cleanroom monitoring apparatus for monitoring the interior of a cleanroom in which a removable floor surface is disposed on a floor. This monitoring apparatus includes a monitoring camera that images the floor surface of a passage through which workers can pass. Furthermore, the monitoring apparatus includes a monitoring unit that detects, from an image signal obtained by the monitoring camera, whether an opening from which the floor surface has been removed is present, detects, if an opening is present, from the image signal of the monitoring camera whether a worker approaching the opening is present, and outputs an alarm signal when a worker is detected; and an alarm generating means that receives the alarm signal from the monitoring unit and issues an alarm.

### SUMMARY

Disclosed herein is a monitoring method for monitoring an interior of a cleanroom in which removable floor tiles are disposed on a floor. The method may include: generating three-dimensional data of the interior of the cleanroom from a ranging result using electromagnetic waves; comparing a height of each part of the interior of the cleanroom indicated by the three-dimensional data, with a predetermined reference height; and detecting an opening in the floor from which a floor tile has been removed, based on a result of the comparing.

Additionally, a monitoring apparatus for monitoring an interior of a cleanroom in which removable floor tiles are disposed on a floor is disclosed herein. The monitoring apparatus may include: a data generator configured to generate three-dimensional data of the interior of the cleanroom from a ranging result using electromagnetic waves; and circuitry configured to: compare a height of each part of the interior of the cleanroom indicated by the three-dimensional data, with a predetermined reference height; and detect an opening in the floor from which a floor tile has been removed, based on a result of comparing the height of each part with the reference height.

Furthermore, a non-transitory memory device having instructions stored thereon that, in response to execution by a processing device, cause the processing device to perform operations for monitoring an interior of a cleanroom in which removable floor tiles are disposed on a floor is disclosed herein. The operations may include: generating three-dimensional data of the interior of the cleanroom from a ranging result using electromagnetic waves; comparing a height of each part of the interior of the cleanroom indicated by the three-dimensional data, with a predetermined reference height; and detecting an opening in the floor from which a floor tile has been removed, based on a result of the comparing.

### BRIEF DESCRIPTION OF THE DRAWINGS

FIG. 1 is a block diagram illustrating a schematic configuration of an example monitoring system having a monitoring apparatus.

FIG. 2 is a diagram for explaining a LiDAR unit.

FIG. 3 is a diagram for explaining a LiDAR unit.

FIG. 4 is an example functional block diagram of a controller of the monitoring apparatus relating to monitoring based on three-dimensional data of the interior of a cleanroom.

FIG. 5 is a diagram illustrating an example of an image displayed on a display unit by a display controller.

FIG. 6 is a diagram illustrating a part of an image obtained from data processed by a visualization processor.

FIG. 7 is an example flowchart for explaining an example of a reference height determination flow by the monitoring apparatus.

FIG. 8 is an example flowchart for explaining an example of a monitoring flow by the monitoring apparatus.

FIG. 9 is an example flowchart for explaining an example of a monitoring flow by the monitoring apparatus.

FIG. 10 is another example functional block diagram of a controller of the monitoring apparatus according.

FIG. 11 is an example flowchart for explaining an example of an alarm generation flow in a monitoring flow.

### DETAILED DESCRIPTION

In the following description, with reference to the drawings, the same reference numbers are assigned to the same components or to similar components having the same function, and overlapping description is omitted.

For example, in a semiconductor manufacturing line for manufacturing semiconductor devices, a large number of semiconductor manufacturing apparatuses such as substrate processing apparatuses are disposed in a cleanroom maintained in a clean atmosphere. In such a cleanroom, floor tiles (sometimes called gratings) having a large number of lattice-shaped ventilation portions are disposed on the floor portion. In addition, piping, various electrical equipment, pumps, chemical liquid tanks, and the like are housed in the space below the floor tiles. For example, at the time of installation, maintenance, or failure of such piping, various electrical equipment, pumps, and the like, workers may descend into the space below the floor tiles to perform work, and therefore the floor tiles are removable.

In this way, in a cleanroom, workers can descend into the space below the floor tiles and perform work with the floor tiles removed. However, when a floor tile is removed, an opening is present in the floor surface of the cleanroom formed by the large number of floor tiles, and there is a risk that workers may fall from this opening into the space below. In particular, workers performing other work on the floor tiles may be working without knowing that an opening has been formed, and it has been practiced to alert workers to exercise caution.

The technology described in Patent Literature 1 uses a monitoring camera that images the floor tile surface, detects, based on an image signal obtained by the monitoring camera, whether an opening from which a floor tile has been removed is present, and, if a worker is present, outputs an alarm signal to issue an alarm from an alarm generating means.

Although this technology has improved the safety of workers, there are places where the use of monitoring cameras is not permitted from the perspectives of confidentiality, privacy, and the like.

Therefore, the present disclosure provides a technology capable of detecting, without using a camera, whether an opening from which a floor tile has been removed is present.

### Monitoring System

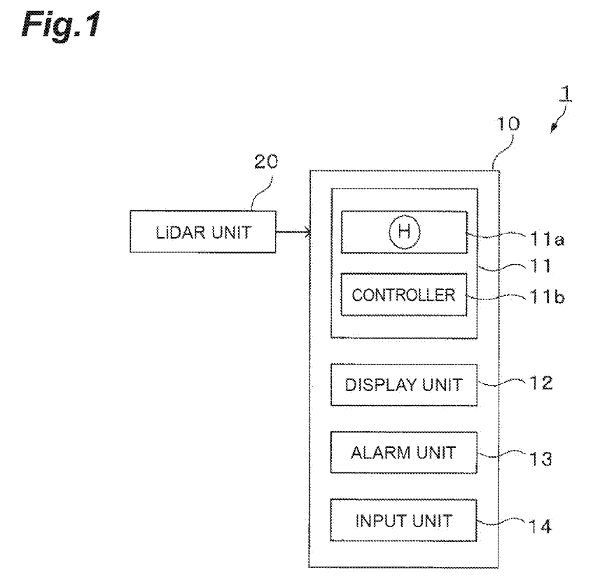

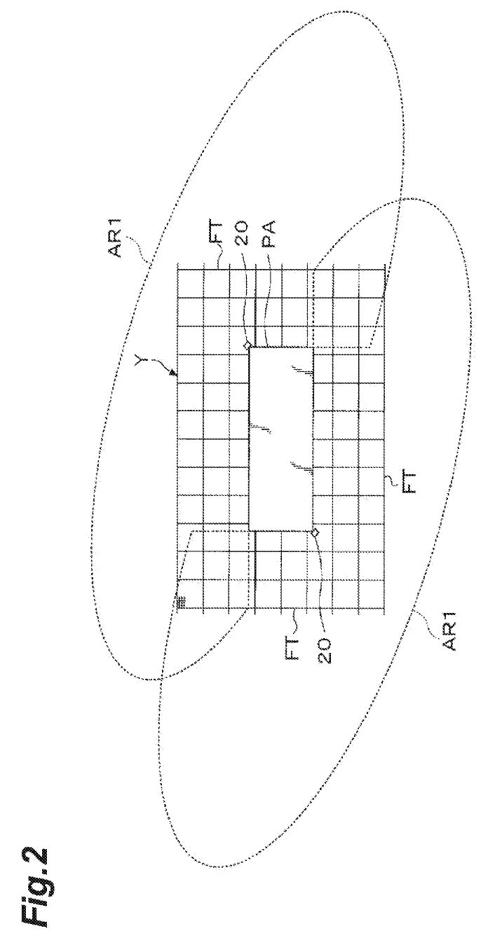

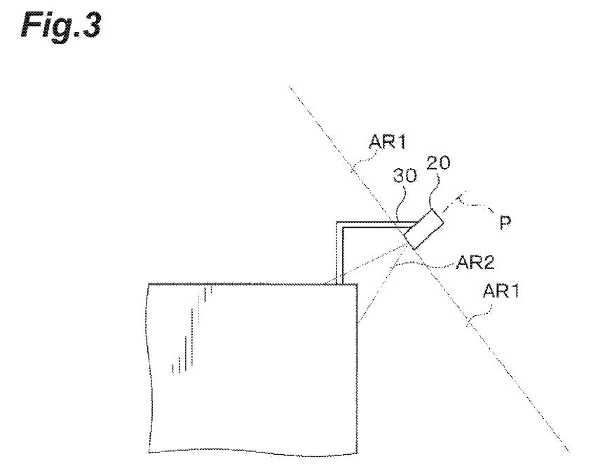

FIG. 1 is a block diagram illustrating a schematic configuration of a monitoring system having a monitoring apparatus. FIGS. 2 and 3 are diagrams for explaining a LiDAR (Light Detection and Ranging) unit to be described later.

The monitoring system 1 of FIG. 1 includes a monitoring apparatus 10 for monitoring the interior of a cleanroom, and a LiDAR unit 20.

The monitoring apparatus 10 includes a main body 11, a display unit 12, an alarm unit 13, and an input unit 14.

The main body 11 is a computer including, for example, a processor such as a CPU, a memory, and the like, and has a storage 11a and a controller 11b.

The storage 11a stores various information, and includes a memory such as a RAM, and a storage device such as an HDD. The storage 11a stores a program including instructions for executing a monitoring flow described later, a program including instructions for executing a reference height determination flow described later, and the like. The above program may be one that was recorded on a computer-readable storage medium H and installed in the main body 11 from the storage medium H. Further, the storage medium H may be a transitory one that stores information temporarily or a non-transitory one that stores information non-temporarily.

The display unit 12 displays various images, and is composed of, for example, a liquid crystal display, an organic EL display, or the like.

The alarm unit 13 issues an alarm by at least one of light and sound. The alarm by sound may be in the form of emitting an alarm sound, or may be in the form of reading out a warning message by voice.

The alarm unit 13 is provided, for example, in a substrate processing apparatus PA (see FIG. 2) as a semiconductor manufacturing apparatus in the cleanroom to be monitored.

The input unit 14 is an element for a worker to input instructions, and includes, for example, a touch panel and a keyboard.

The LiDAR unit 20 is an example of a three-dimensional data generation unit.

The three-dimensional data generation unit (for example, the LiDAR unit 20) generates three-dimensional data of the interior of the cleanroom from a ranging result using electromagnetic waves. For example, the three-dimensional data generation unit includes an output unit, a detection unit, that is, a sensor, and a computation unit. In the three-dimensional data generation unit, the output unit outputs electromagnetic waves, and the detection unit detects reflected waves of the electromagnetic waves output from the output unit. Further, the computation unit of the three-dimensional data generation unit calculates the distance to each measurement point in the cleanroom based on the detection result of the detection unit, and also calculates the coordinate values (x, y, z coordinate values) of each measurement point based on the calculation result, thereby generating point cloud data indicating the shape of the interior of the cleanroom as three-dimensional data of the interior of the cleanroom. The computation unit of the three-dimensional data generation unit is constituted by, for example, a microcontroller.

The LiDAR unit 20 uses laser light as the electromagnetic waves and uses near-infrared laser light. The output unit of the LiDAR unit 20 as the output unit of the three-dimensional data generation unit includes a laser oscillator that generates laser light, and a driver that drives the laser oscillator. Further, the detection unit of the LiDAR unit 20 as the detection unit of the three-dimensional data generation unit includes a photodiode that receives laser light.

As illustrated in FIG. 2, the LiDAR unit 20 is disposed such that a floor Y of the cleanroom to which floor tiles FT are detachably attached is located within a region AR1 in which electromagnetic waves (for example, laser light) can be irradiated (that is, a region in which point cloud data as three-dimensional data can be generated). For example, the LiDAR unit 20 is fixed such that, at least within the region AR1 in which electromagnetic waves can be irradiated (hereinafter referred to as the electromagnetic wave irradiation region), a region of the floor Y of the cleanroom where the substrate processing apparatus PA as a semiconductor manufacturing apparatus is not placed, that is, a region through which workers pass, is located.

The LiDAR unit 20 may have an annular electromagnetic wave irradiation region AR1 as viewed from the direction of the axis P of the LiDAR unit, and a non-irradiation region AR2 that is surrounded by the electromagnetic wave irradiation region AR1 as viewed from the same direction and in which electromagnetic waves are not irradiated. The LiDAR unit 20 may be disposed such that the axis P faces the substrate processing apparatus PA. For example, the LiDAR unit 20 may be fixed such that the axis P faces the substrate processing apparatus PA, and the floor Y of the cleanroom is located within the electromagnetic wave irradiation region AR1 and not within the non-irradiation region AR2. For example, when the LiDAR unit 20 is attached to the upper part of the substrate processing apparatus PA, the LiDAR unit 20 may be attached so as to face diagonally downward such that the substrate processing apparatus PA is within the non-irradiation region AR2.

Further, a plurality of LiDAR units 20 (two in the example of the figure) are arranged so as to be able to generate point cloud data of the entire circumference of the substrate processing apparatus PA, that is, so that the entire circumference of the substrate processing apparatus PA is surrounded by the electromagnetic wave irradiation region AR1 as illustrated in FIG. 2. Note that, in the following description, of the two LiDAR units 20, one may be referred to as a first LiDAR unit 201 and the other as a second LiDAR unit 202.

For example, the LiDAR unit 20 is attached to the ceiling of the cleanroom. Further, the LiDAR unit 20 may be attached to the substrate processing apparatus PA. For example, the LiDAR unit 20 is attached at a position slightly separated from the substrate processing apparatus PA via a mounting member 30, as illustrated in FIG. 3. Further, the LiDAR unit 20 may be supported by a stand (not illustrated) serving as a support member placed on the floor of the cleanroom.

The three-dimensional data of the interior of the cleanroom (for example, point cloud data indicating the shape of the interior of the cleanroom) generated, that is, acquired, by the LiDAR unit 20 is output to the monitoring apparatus 10 and stored in the storage 11a.

The monitoring apparatus 10 monitors the cleanroom based on the three-dimensional data of the interior of the cleanroom generated by each LiDAR unit 20. During monitoring by the monitoring apparatus 10, each LiDAR unit 20 sequentially generates the three-dimensional data. Further, each LiDAR unit 20 generates the three-dimensional data at least once before monitoring by the monitoring apparatus 10 in order to determine a reference height to be described later.

### Controller 11b of Monitoring Apparatus 10

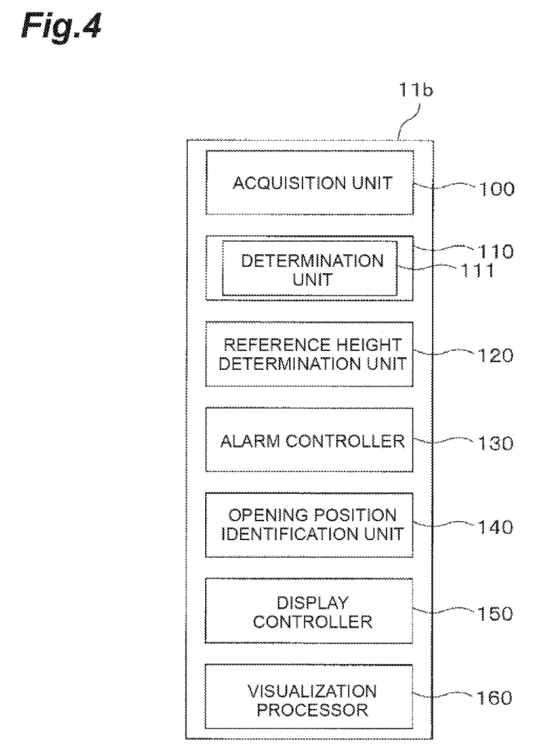

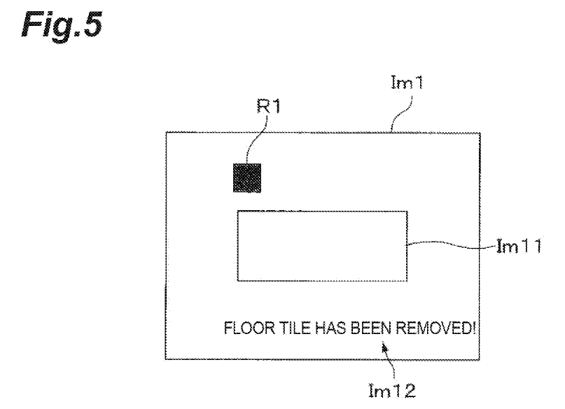

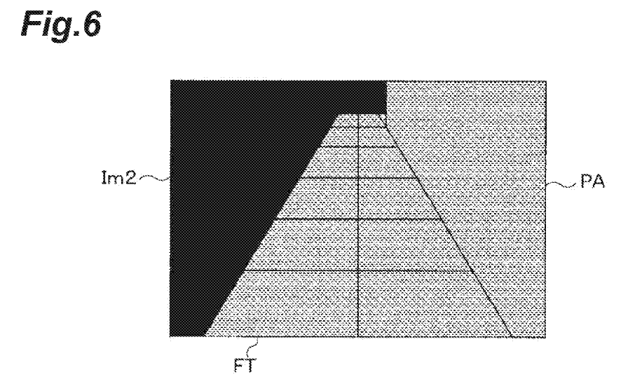

FIG. 4 is a functional block diagram of the controller 11b of the monitoring apparatus 10, relating to monitoring based on three-dimensional data of the interior of the cleanroom. FIG. 5 is a diagram illustrating an example of an image displayed on the display unit 12 by a display controller 150 to be described later. FIG. 6 is a diagram illustrating a part of an image obtained from data processed by a visualization processor 160 to be described later.

As illustrated in FIG. 4, the controller 11b includes an acquisition unit 100, a detector 110, a reference height determination unit 120, an alarm controller 130, an opening position identification unit 140, a display controller 150, and a visualization processor 160, which are each realized by a processor such as a CPU reading out and executing a program stored in the storage 11a.

The acquisition unit 100 acquires, from among the three-dimensional data of the interior of the cleanroom sequentially generated by the LiDAR unit 20 and stored in the storage 11a, data and the like to be used by the detector 110 for detection during monitoring. The acquisition unit 100 acquires, as data to be used by the detector 110 for detection during monitoring, for example, at least the most recent three-dimensional data, and acquires, for each LiDAR unit 20, at least the most recent three-dimensional data.

The detector 110 detects, based on the three-dimensional data of the interior of the cleanroom, an opening from which a floor tile FT has been removed. For example, the detector 110 detects the opening based on the three-dimensional data of the interior of the cleanroom acquired by the acquisition unit 100. The detector 110 includes a determination unit 111.

The determination unit 111 uses a reference height Ts. The reference height Ts is predetermined before detection by the detector 110, based on three-dimensional data of the interior of the cleanroom generated in advance of the detection. The determination unit 111 compares this reference height Ts with the height of each part of the interior of the cleanroom indicated by the three-dimensional data of the interior of the cleanroom generated during monitoring and determines whether an opening is present based on the comparison result. For example, the determination unit 111 compares the reference height Ts with the height of each part of the interior of the cleanroom indicated by the three-dimensional data of the interior of the cleanroom acquired by the acquisition unit 100 and determines whether an opening is present based on the comparison result.

The determination unit 111 determines, for example, that an opening is present, that is, that an opening has been detected, if there is a part in the cleanroom whose height is lower than the reference height Ts by at least a threshold Th1. The threshold Th1 is set to a value larger than the thickness of the floor tile FT, for example. For example, the threshold Th1 is, for example, 10 cm.

The determination unit 111 may determine that an opening is present if there is a part in the cleanroom whose height is lower than the reference height Ts by at least the threshold Th1, and the area of a cluster of the part in a plan view is larger than a threshold Th2. The area is determined, for example, from a collection of XY coordinates of points having z coordinate values lower than the reference height Ts by at least the threshold Th1 in the point cloud data. The threshold Th2 is set based on the area of the floor tile FT, for example. For example, the threshold Th2 is, for example, 25% or more of the area of the floor tile FT.

By using the area in this way, false detection of openings, such as detecting a gap between floor tiles FT as an opening, can be reduced.

The reference height determination unit 120 predetermines the reference height Ts before detection by the detector 110, that is, before the start of monitoring by the monitoring apparatus 10, based on previously generated three-dimensional data of the interior of the cleanroom. For example, the reference height determination unit 120 determines the reference height Ts before the determination by the determination unit 111, based on three-dimensional data of the interior of the cleanroom generated before the start of the determination by the determination unit 111.

For example, the reference height determination unit 120 automatically determines, as the reference height, the height with the highest frequency of occurrence among the heights in the three-dimensional data of the interior of the cleanroom (for example, the z coordinate values in the point cloud data). The reason for this determination is that the height of the upper surface of the floor tile FT, that is, the floor surface, is the most frequently occurring height in the cleanroom.

The alarm controller 130 causes the alarm unit 13 to issue an alarm when an opening is detected by the detector 110. For example, the alarm controller 130 controls the alarm unit 13 to issue an alarm when the determination unit 111 of the detector 110 determines that an opening is present.

Further, the alarm controller 130 causes the alarm from the alarm unit 13 to stop when the opening is no longer detected by the detector 110 after causing the alarm unit 13 to issue an alarm.

The opening position identification unit 140 identifies the position of the opening based on the three-dimensional data of the interior of the cleanroom generated during monitoring, when an opening is detected by the detector 110. For example, the opening position identification unit 140 identifies the position of the opening based on the three-dimensional data of the interior of the cleanroom acquired by the acquisition unit 100, when an opening is detected by the detector 110. For example, the opening position identification unit 140 calculates the centroid position of the cluster of parts whose heights are lower than the reference height Ts by at least the threshold Th1 (for example, the centroid position in the horizontal direction, that is, the x coordinate value and y coordinate value of the centroid) and identifies the centroid position as the position of the opening.

The display controller 150 causes the display unit 12 to display an image indicating the position of the opening identified by the opening position identification unit 140. The image is, for example, a top view image Im1 schematically illustrating a top view of the floor, as illustrated in FIG. 5, and highlighting a region R1 corresponding to the opening. The top view image Im1 is, for example, divided into a plurality of regions, and highlights the region R1 at a position corresponding to the position of the opening. Information associating the position of the opening with the position of the region in the top view image Im1 is stored in the storage 11a and is referenced by the display controller 150 at the time of generation of the top view image Im1.

Note that the top view image Im1 also includes an image Im11 simulating the substrate processing apparatus PA. This allows workers to readily grasp the relative positional relationship between the opening and the substrate processing apparatus PA.

Further, the top view image Im1 may include a warning message Im12 indicating that an opening has been formed.

The visualization processor 160 processes the three-dimensional data of the interior of the cleanroom so as to be visualizable. For example, the visualization processor 160 converts the three-dimensional data of the interior of the cleanroom generated by the LiDAR unit 20 into data representing a pseudo-point-cloud image Im2 of the interior of the cleanroom, a part of which is illustrated in FIG. 6. The pseudo-point-cloud image Im2 is an image that depicts the interior of the cleanroom as seen from the position of the LiDAR unit 20 in a pointillistic manner, and each point in the image corresponds to each point of the point cloud data serving as the three-dimensional data.

The visualization processor 160 may be omitted.

### Reference Height Determination Flow

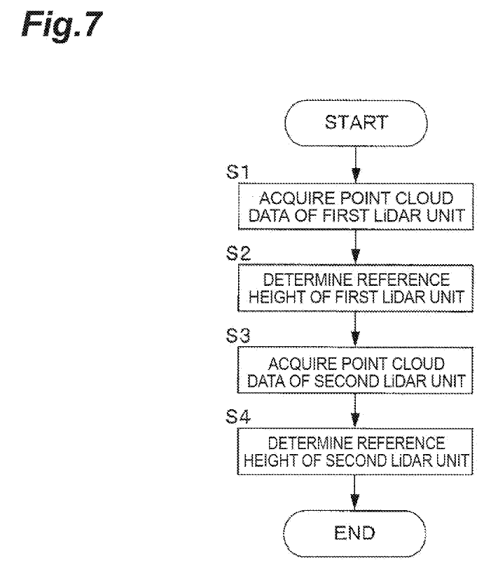

Next, before describing an example of a monitoring flow by the monitoring apparatus 10, an example of a reference height determination flow by the monitoring apparatus 10 will be described with reference to FIG. 7. FIG. 7 is a flowchart for explaining an example of the reference height determination flow by the monitoring apparatus 10. The determination flow is executed prior to the monitoring flow.

### Operation S1: Acquisition of Point Cloud Data of First LiDAR Unit 201

First, the acquisition unit 100 acquires, as point cloud data of the first LiDAR unit 201 for reference height determination, point cloud data stored in the storage 11a that was generated by the first LiDAR unit 201 before the start of monitoring by the monitoring apparatus 10.

### Operation S2: Determination of Reference Height of First Lidar Unit 201

Next, the reference height determination unit 120 determines the reference height Ts of the first LiDAR unit 201 based on the point cloud data of the first LiDAR unit 201 for reference height determination acquired by the acquisition unit 100.

For example, the reference height determination unit 120 automatically determines, as the reference height Ts of the first LiDAR unit 201, the z coordinate value with the highest frequency of occurrence among the z coordinate values in the point cloud data of the first LiDAR unit 201 for reference height determination.

The determination of the reference height Ts of the first LiDAR unit 201 by the reference height determination unit 120 may be performed as follows.

That is, first, the reference height determination unit 120 determines the z coordinate value with the highest frequency of occurrence among the z coordinate values in the point cloud data of the first LiDAR unit 201 for reference height determination as a candidate for the reference height Ts of the first LiDAR unit 201. At the same time, the visualization processor 160 processes the point cloud data of the first LiDAR unit 201 for reference height determination so as to be visualizable and generates data representing the aforementioned pseudo-point-cloud image Im2 of the interior of the cleanroom. Based on the determination result by the reference height determination unit 120 and the processing result by the visualization processor 160, the display controller 150 causes the display unit 12 to display an image that is the pseudo-point-cloud image Im2 of the interior of the cleanroom and in which a part whose height matches the candidate for the reference height Ts of the first LiDAR unit 201 is highlighted. Then, during this display, the reference height determination unit 120 may determine the candidate for the reference height Ts of the first LiDAR unit 201 as the reference height Ts of the first LiDAR unit 201, based on a result input to the input unit 14 by a worker. Thus, the reference height Ts can be more reliably matched with the height of the upper surface of the floor tile FT, that is, the floor surface.

### Operation S3: Acquisition of Point Cloud Data of Second LiDAR Unit 202

Further, the acquisition unit 100 acquires, as point cloud data of the second LiDAR unit 202 for reference height determination, point cloud data that is stored in the storage 11a that was generated by the second LiDAR unit 202 before the start of monitoring by the monitoring apparatus 10.

### Operation S4: Determination of Reference Height of Second LiDAR Unit 202

Next, the reference height determination unit 120 determines the reference height Ts of the second LiDAR unit 202 based on the point cloud data of the second LiDAR unit 202 for reference height determination acquired by the acquisition unit 100.

The method for determining the reference height Ts of the second LiDAR unit 202 is the same as that for determining the reference height Ts of the first LiDAR unit 201.

In this way, the reference height Ts is determined for each LiDAR unit 20.

### <Monitoring Flow>

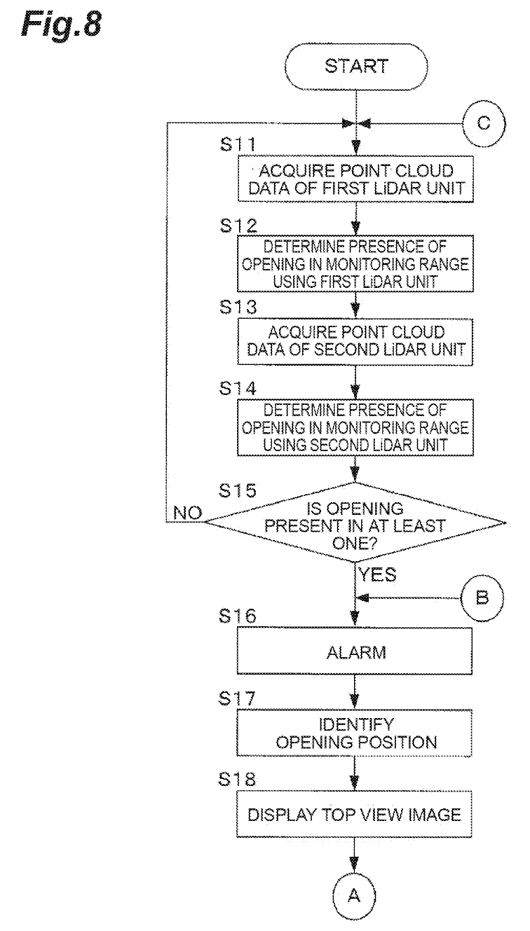

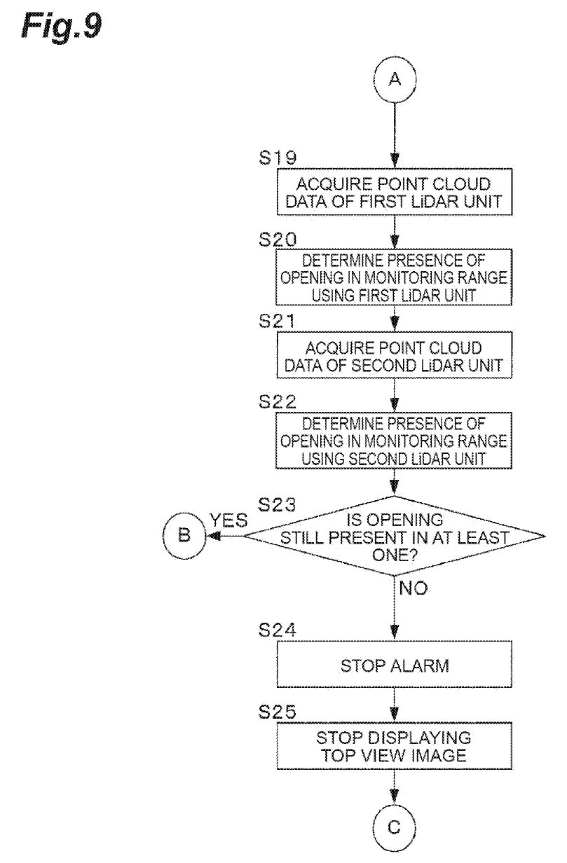

Next, an example of a monitoring flow by the monitoring apparatus 10 will be described with reference to FIGS. 8 and 9. FIGS. 8 and 9 are flowcharts for explaining an example of the monitoring flow by the monitoring apparatus 10.

### Operation S11: Acquisition of Point Cloud Data of First LiDAR Unit 201

First, the acquisition unit 100 acquires, as point cloud data of the first LiDAR unit 201 for monitoring, for example, the most recent data among the point cloud data generated by the first LiDAR unit 201 and stored in the storage 11a.

### Operation S12: Determination of Whether an Opening is Present in the Monitoring Range Using the First LiDAR Unit 201

Next, the determination unit 111 compares the height of each point in the cleanroom indicated by the point cloud data of the first LiDAR unit 201 for monitoring, which is acquired by the acquisition unit 100, with the reference height Ts of the first LiDAR unit 201, and determines whether an opening is present in the monitoring range using the first LiDAR unit 201 based on the comparison result.

For example, the determination unit 111 determines that an opening is present in the monitoring range using the first LiDAR unit 201 if the point cloud data of the first LiDAR unit 201 for monitoring includes a set of mutually adjacent points, that is, a cluster of points, satisfying the following conditions (A) and (B).

(A) The height of each point is lower than the reference height Ts of the first LiDAR unit 201 by at least the threshold Th1.

(B) The projected area of the set of points onto the xy plane is larger than the threshold Th2.

### Operation S13: Acquisition of Point Cloud Data of Second LiDAR Unit 202

Further, the acquisition unit 100 acquires, as point cloud data of the second LiDAR unit 202 for monitoring, for example, the most recent data among the point cloud data generated by the second LiDAR unit 202 and stored in the storage 11a.

### Operation S14: Determination of Whether an Opening is Present in the Monitoring Range Using the Second LiDAR Unit 202

Next, the determination unit 111 compares the height of each point in the cleanroom indicated by the point cloud data of the second LiDAR unit 202 for monitoring, which is acquired by the acquisition unit 100, with the reference height Ts of the second LiDAR unit 202, and determines whether an opening is present in the monitoring range using the second LiDAR unit 202 based on the comparison result.

For example, the determination unit 111 determines that an opening is present in the monitoring range using the second LiDAR unit 202 if the point cloud data of the second LiDAR unit 202 for monitoring includes a set of mutually adjacent points, that is, a cluster of points, satisfying the following condition (C) and the aforementioned condition (B).

(C) The height of each point is lower than the reference height Ts of the second LiDAR unit 202 by at least the threshold Th1.

Then, if no opening is present in either the monitoring range using the first LiDAR unit 201 or the monitoring range using the second LiDAR unit 202 (operation S15, NO), that is, if it is not determined that an opening is present in either operation S12 or operation S14, the monitoring flow returns to operation S11.

On the other hand, if an opening is present in at least one of the monitoring range using the first LiDAR unit 201 and the monitoring range using the second LiDAR unit 202 (operation S15, YES), that is, if it is determined that an opening is present in at least one of operation S12 and operation S14, the monitoring flow proceeds to operation S16 and subsequent operations.

### Operation S16: Alarm

In operation S16, the alarm controller 130 causes the alarm unit 13 to issue an alarm.

### Operation S17: Opening Position Identification

Further, the opening position identification unit 140 identifies the position of the opening.

For example, the opening position identification unit 140 calculates the centroid position (for example, the x coordinate value and Y coordinate value of the centroid) of whichever is present among the set of points described above included in the point cloud data of the first LiDAR unit 201 for monitoring and the set of points described above included in the point cloud data of the second LiDAR unit 202 for monitoring. The opening position identification unit 140 identifies the calculated centroid position as the position of the opening.

### Operation S18: Top View Image Display

Next, the display controller 150 causes the display unit 12 to display the aforementioned top view image Im1 indicating the position of the opening, based on the position of the opening identified by the opening position identification unit 140.

Operations S17 and S18 may be performed before operation S16, or may be performed in parallel with operation S16.

After operations S16 to S18, operations S19 to S22 similar to the aforementioned operations S11 to S14 are performed.

If an opening is still present in at least one of the monitoring range using the first LiDAR unit 201 and the monitoring range using the second LiDAR unit 202 (operation S23, YES), that is, if it is determined that an opening is present in at least one of operation S20 and operation S22, the monitoring flow returns to operations S16 to S18.

On the other hand, if no opening is present any longer in either the monitoring range using the first LiDAR unit 201 or the monitoring range using the second LiDAR unit 202 (operation S23, NO), that is, if it is not determined that an opening is present in either operation S20 or operation S22, the monitoring flow proceeds to operation S24 and subsequent operations.

### Operation S24: Alarm Stop

In operation S24, the alarm controller 130 controls the alarm unit 13 to stop the alarm.

### Operation S25: Top View Image Display Stop

Further, the display controller 150 controls the display unit 12 to stop displaying the aforementioned top view image Im1 indicating the position of the opening.

Operation S25 may be performed before operation S24, or may be performed in parallel with operation S24.

After operations S24 and S25, the monitoring flow returns to operation S1.

As described above, the monitoring method for monitoring the interior of a cleanroom in which floor tiles FT are disposed on the floor includes a operation of detecting, based on three-dimensional data of the interior of the cleanroom, an opening from which a floor tile FT has been removed. The operation of detecting includes a operation of comparing a reference height Ts predetermined based on previously generated three-dimensional data of the interior of the cleanroom, with a height of each part of the interior of the cleanroom indicated by the three-dimensional data of the interior of the cleanroom generated during monitoring, and determining whether an opening is present based on the comparison result.

Therefore, if an opening is present, workers can recognize that an opening has been formed, by an alarm being issued, for example, and the safety of workers can be improved. Further, in the present embodiment, the three-dimensional data of the interior of the cleanroom used for detecting the opening is generated from a ranging result using electromagnetic waves. That is, in the present embodiment, a camera is not required for detecting the opening. Therefore, even in cases where the use of a camera is not permitted from the perspective of confidentiality and privacy, the safety of the workability can be improved.

### (Second Embodiment)

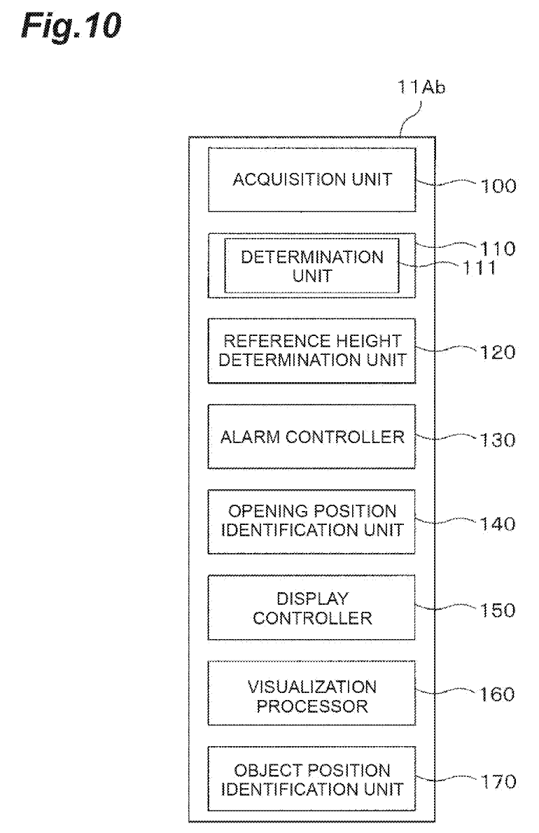

FIG. 10 is a functional block diagram of the controller of the monitoring apparatus according to the second embodiment.

In the present embodiment, as illustrated in FIG. 10, a controller 11Ab includes, in addition to the acquisition unit 100, the detector 110, the reference height determination unit 120, the alarm controller 130, the opening position identification unit 140, the display controller 150, and the visualization processor 160, an object position identification unit 170. The visualization processor 160 may be omitted. The object position identification unit 170 is realized, similarly to the acquisition unit 100 and the like, by a processor such as a CPU reading out and executing a program stored in the storage 11a.

The object position identification unit 170 identifies, based on three-dimensional data of the interior of the cleanroom generated during monitoring, the position of a part in the cleanroom that is higher than the reference height Ts. The object position identification unit 170 calculates the centroid position of the cluster of parts whose heights are higher than the reference height Ts by at least a threshold Th3 (specifically, the centroid position in the horizontal direction, that is, the x coordinate value and y coordinate value of the centroid), and identifies the centroid position as the position of the part higher than the reference height Ts (hereinafter referred to as an object). The threshold Th3 is, for example, 60 cm.

In the present embodiment, the alarm controller 130 causes the alarm unit 13 to issue an alarm with content in accordance with the distance between the position of the object and the position of the opening.

For example, the alarm controller 130 causes the alarm unit 13 to issue an alarm at a louder volume than normal (that is, when no object is present within a predetermined range from the opening), or an alarm with a different sound from normal, when an object is located within a predetermined range from the opening.

This makes it possible to further improve the safety of workers.

### <Alarm Generation Flow>

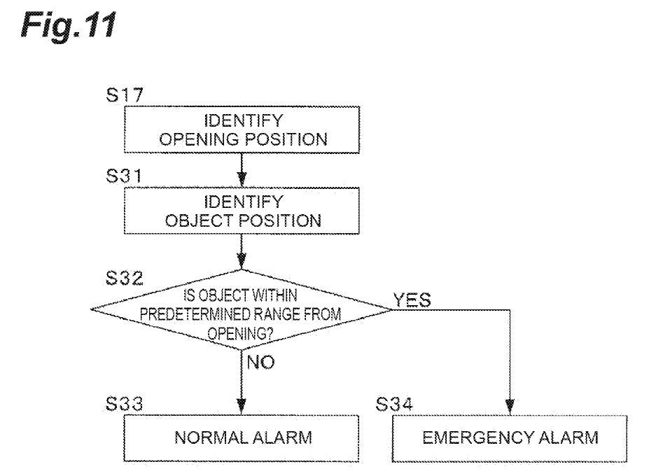

Next, an example of an alarm generation flow in the monitoring flow according to the present embodiment will be described with reference to FIG. 11. FIG. 11 is a flowchart for explaining an example of the alarm generation flow according to the present embodiment.

In the present embodiment, if an opening is present, the aforementioned operation S17 is performed. That is, if it is determined that an opening is present in at least one of operation S12 and operation S14, the opening position identification unit 140 identifies the position of the opening.

### Operation S31: Object Position Identification

Further, the object position identification unit 170 identifies the position of the object.

For example, the object position identification unit 170 calculates the centroid position (for example, the x coordinate value and Y coordinate value of the centroid) of whichever is present among the set of points satisfying the following condition (D) included in the point cloud data of the first LiDAR unit 201 for monitoring and the set of points satisfying the following condition (E) included in the point cloud data of the second LiDAR unit 202 for monitoring. The object position identification unit 170 identifies the calculated centroid position as the position of the object.

(D) The height of each point is higher than the reference height Ts of the first LiDAR unit 201 by at least the threshold Th3.

(E) The height of each point is higher than the reference height Ts of the second LiDAR unit 202 by at least the threshold Th3.

Operation S31 may be performed before operation S17, or may be performed in parallel with operation S17.

### Operation S32: Position Determination

After that, the alarm controller 130 determines whether an object is located within a predetermined range from the opening.

For example, the alarm controller 130 first calculates the distance from the opening to the object based on the position of the opening identified in operation S17 and the position of the object identified in operation S31. Next, the alarm controller 130 determines whether the calculated distance is equal to or less than a predetermined threshold Th4. The alarm controller 130 determines that no object is located within the predetermined range from the opening if the calculated distance exceeds the predetermined threshold Th4 and determines that an object is located within the predetermined range from the opening if the calculated distance is equal to or less than the predetermined threshold Th4.

### Operation S33: Normal Alarm

If no object is located within the predetermined range from the opening (operation S32 , NO), the alarm controller 130 causes the alarm unit 13 to issue a normal alarm.

### Operation S34: Emergency Alarm

If an object is located within the predetermined range from the opening (operation S32, YES), the alarm controller 130 causes the alarm unit 13 to issue an emergency alarm.

The emergency alarm may be an alarm at a louder volume than the normal alarm, or may be an alarm with a different sound from the normal alarm. Further, the emergency alarm may be an alarm that is both louder than the normal alarm and has a different sound from the normal alarm.

The alarm controller 130 may cause the alarm unit 13 to issue an alarm at a volume that increases as the object gets closer to the opening, when an object is located within the predetermined range from the opening. According to this, in a case where an object continues to be located within the predetermined range from the opening while the object position identification unit 170 repeatedly identifies the position of the object, the volume of the alarm from the alarm unit 13 increases as the object approaches the opening, and the volume of the alarm from the alarm unit 13 decreases as the object moves away from the opening.

When an object is located within the predetermined range from the opening, if the position of the object does not change for a certain period of time, the alarm controller 130 may cause the alarm from the alarm unit 13 to return to the normal one.

Further, the object position identification unit 170 may determine, for an object located within the predetermined range from the opening, whether the object is a cone or a bar that is recommended to be installed around the opening. This determination is performed, for example, by pattern matching based on information on the shape of a cone or a bar acquired in advance. Furthermore, this determination may be performed based on a model created in advance by machine learning using point cloud data generated by the LiDAR unit 20. The accuracy of the determination may be improved.

The alarm controller 130 may cause the alarm unit 13 to issue a normal alarm if it is determined that the object located within the predetermined range from the opening is a cone or a bar and may cause the alarm unit 13 to issue an alarm at a louder volume than normal or an alarm with a different sound from normal if it is not determined that the object is a cone or a bar.

Furthermore, when an object is located within the predetermined range from the opening, the alarm controller 130 may cause the alarm from the alarm unit 13 to return to the normal one when the position of the object does not change for a certain period of time and it is determined that the object is a cone or a bar.

### Other Modifications

When determining whether an opening is present and determining the reference height Ts, the three-dimensional data may be subjected to masking processing so that three-dimensional data of only a predetermined part of the interior of the cleanroom is used for at least one of these. This masking processing is performed by a masking unit. The masking unit is realized by a processor such as a CPU reading out and executing a program stored in the storage 11a. At least one of the reference height determination unit 120 and the opening position identification unit 140 may also serve as the masking unit. Further, the three-dimensional data of only a predetermined part of the interior of the cleanroom refers to, for example, three-dimensional data of only a part located within a predetermined distance from the LiDAR unit 20 in the cleanroom. Since the three-dimensional data generated by the LiDAR unit 20 is more accurate for parts closer to the LiDAR unit 20, by doing so as described above, whether an opening is present may more accurately be determined, and also a more accurate reference height Ts may be obtained.

Three-dimensional data used for other purposes may also be similarly subjected to masking processing by the masking unit.

Note that the floor tile FT attached to the floor of the cleanroom may be transparent. There are cases where the change in the three-dimensional data generated by the LiDAR unit 20 is small between the state in which the transparent floor tile FT is attached and the state in which it is removed and an opening is formed. For example, when the electromagnetic waves irradiated by the LiDAR unit 20 pass through the transparent floor tile FT, the change is small. Therefore, the following polarizing film may be attached to the transparent floor tile FT. That is, a polarizing film that reflects the electromagnetic waves irradiated by the LiDAR unit 20 toward the LiDAR unit 20 but transmits visible light from the position of a worker facing the transparent grating, may be attached to the transparent floor tile FT. An opening caused by the transparent floor tile FT may more reliably be detected when monitoring is performed based on the three-dimensional data generated by the LiDAR unit 20.

In the above, the LiDAR unit 20 using light (for example, near-infrared light) as electromagnetic waves has been cited as an example of the three-dimensional data generation unit, but the present disclosure is not limited to this. For example, the three-dimensional data generation unit may be one that uses millimeter waves as electromagnetic waves.

Further, in the above, the number of LiDAR units 20 installed was two, but it may be three or more (for example, four). By increasing the number, the accuracy of detecting openings can be improved.

The disclosure should be considered as illustrative in all respects and not restrictive. The above disclosure may be omitted, substituted, or modified in various forms without departing from the scope and spirit of the appended claims. For example, the constituent elements of the above disclosure can be combined arbitrarily. From such arbitrary combinations, the actions and effects of each of the constituent elements involved in the combination are naturally obtained, and other actions and other effects that are apparent to those skilled in the art from the description of the present specification are also obtained.

Further, the effects described in the present specification are merely illustrative and are not limiting. That is, the technology according to the present disclosure can exhibit other effects that are apparent to those skilled in the art from the description of the present specification, in addition to or instead of the above effects.

Note that the following configuration examples also belong to the technical scope of the present disclosure.

(1) A monitoring method for monitoring an interior of a cleanroom in which removable floor tiles are disposed on a floor,

the method comprising a step of detecting, based on three-dimensional data of the interior of the cleanroom generated from a ranging result using electromagnetic waves, an opening from which a floor tile has been removed,

wherein the step of detecting comprises a step of comparing a reference height predetermined based on previously generated three-dimensional data of the interior of the cleanroom, with a height of each part of the interior of the cleanroom indicated by the three-dimensional data of the interior of the cleanroom generated during monitoring, and determining whether the opening is present based on a comparison result.

(2) The monitoring method according to (1), further comprising a step of determining, before the step of detecting, the reference height based on the previously generated three-dimensional data of the interior of the cleanroom.

(3) The monitoring method according to (1) or (2), wherein in the step of determining, the opening is determined to be present if a part in the cleanroom has a height lower than the reference height by at least a threshold.

(4) The monitoring method according to any one of (1) to (3), further comprising a step of issuing an alarm if the opening is detected in the step of detecting.

(5) The monitoring method according to (4), further comprising a step of stopping the alarm if the opening is no longer detected after issuing the alarm.

(6) The monitoring method according to any one of (1) to (5), further comprising a step of identifying, if the opening is detected in the step of detecting, a position of the opening based on the three-dimensional data of the interior of the cleanroom generated during the monitoring.

(7) The monitoring method according to (6), further comprising a step of displaying an image indicating the position of the opening identified in the step of identifying.

(8) The monitoring method according to (7), further comprising a step of stopping displaying of the image if the opening is no longer detected after displaying the image.

(9) The monitoring method according to any one of (1) to (8), further comprising a step of performing masking processing on the three-dimensional data so that three-dimensional data of only a predetermined part of the interior of the cleanroom is used for at least one of determining the reference height and determining whether the opening is present.

(10) The monitoring method according to (4) or (5), further comprising:

a step of identifying, if the opening is detected in the step of detecting, a position of the opening based on the three-dimensional data of the interior of the cleanroom generated during the monitoring, and

a step of identifying a position of a part in the cleanroom that is higher than the reference height based on the three-dimensional data of the interior of the cleanroom generated during the monitoring,

wherein in the step of issuing the alarm, the alarm is issued with content in accordance with a distance from the part higher than the reference height to the opening.

(11) The monitoring method according to any one of (1) to (10), comprising a step of processing the three-dimensional data for visualization.

(12) A monitoring apparatus for monitoring an interior of a cleanroom in which removable floor tiles are disposed on a floor,

the monitoring apparatus comprising a detector configured to detect, based on three-dimensional data of the interior of the cleanroom generated from a ranging result using electromagnetic waves, an opening from which a floor tile has been removed,

wherein the detector comprises a determination unit configured to compare a reference height predetermined based on previously generated three-dimensional data of the interior of the cleanroom, with a height of each part of the interior of the cleanroom indicated by the three-dimensional data of the interior of the cleanroom generated during monitoring, and determine whether the opening is present based on a comparison result.

(13) The monitoring apparatus according to (12), further comprising a reference height determination unit configured to determine, before detection by the detector, the reference height based on the previously generated three-dimensional data of the interior of the cleanroom.

(14) The monitoring apparatus according to (12) or (13), wherein the determination unit is configured to determine that the opening is present if a part in the cleanroom has a height lower than the reference height by at least a threshold.

(15) The monitoring apparatus according to any one of (12) to (14), further comprising an alarm controller configured to cause an alarm unit to issue an alarm if the opening is detected by the detector.

(16) The monitoring apparatus according to any one of (12) to (15), further comprising an opening position identification unit configured to identify, if the opening is detected by the detector, a position of the opening based on the three-dimensional data of the interior of the cleanroom generated during the monitoring.

(17) The monitoring apparatus according to (16), further comprising a display controller configured to cause a display unit to display an image indicating the position of the opening identified by the opening position identification unit.

(18) The monitoring apparatus according to any one of (12) to (17), further comprising a masking unit configured to perform masking processing on the three-dimensional data so that three-dimensional data of only a predetermined part of the interior of the cleanroom is used for at least one of determining the reference height and determining whether the opening is present.

(19) The monitoring apparatus according to (15), further comprising:

an opening position identification unit configured to identify, if the opening is detected by the detector, a position of the opening based on the three-dimensional data of the interior of the cleanroom generated during the monitoring, and

an object position identification unit configured to identify a position of a part in the cleanroom that is higher than the reference height based on the three-dimensional data of the interior of the cleanroom generated during the monitoring,

wherein the alarm controller is configured to cause the alarm to be issued with content in accordance with a distance from the part higher than the reference height to the opening.

(20) A readable computer storage medium storing a program that operates on a computer of a controller configured to control a monitoring apparatus so as to cause the monitoring apparatus to execute a monitoring method for monitoring an interior of a cleanroom in which removable floor tiles are disposed on a floor,

wherein the monitoring method comprises a step of detecting, based on three-dimensional data of the interior of the cleanroom generated from a ranging result using electromagnetic waves, an opening from which a floor tile has been removed, and

wherein the step of detecting comprises a step of comparing a reference height predetermined based on previously generated three-dimensional data of the interior of the cleanroom, with a height of each part of the interior of the cleanroom indicated by the three-dimensional data of the interior of the cleanroom generated during monitoring, and determining whether the opening is present based on a comparison result.

It is to be understood that not all aspects, advantages and features described herein may necessarily be achieved by, or included in, any one particular example. Indeed, having described and illustrated various examples herein, it should be apparent that other examples may be modified in arrangement and detail.

What is claimed is:

1. A monitoring method for monitoring an interior of a cleanroom in which removable floor tiles are disposed on a floor, the method comprising:
generating three-dimensional data of the interior of the cleanroom from a ranging result using electromagnetic waves;
comparing a height of each part of the interior of the cleanroom indicated by the three-dimensional data, with a predetermined reference height; and
detecting an opening in the floor from which a floor tile has been removed, based on a result of the comparing.

2. The monitoring method according to claim 1, further comprising:
generating, prior to the generating of the three-dimensional data, reference three-dimensional data of the interior of the cleanroom from a ranging result using electromagnetic waves; and
determining the reference height based on the reference three-dimensional data.

3. The monitoring method according to claim 1, wherein the detecting includes detecting the opening in response to determining that a part of the interior of the cleanroom has a height lower than the reference height by at least a threshold.

4. The monitoring method according to claim 1, further comprising issuing an alarm in response to detecting the opening.

5. The monitoring method according to claim 4, further comprising:
generating, after detecting the opening, updated three-dimensional data from a ranging result using electromagnetic waves; and
stopping the alarm in response to determining that the opening is not detected based on the updated three-dimensional data.

6. The monitoring method according to claim 1, further comprising identifying, in response to detecting the opening, a position of the opening based on the three-dimensional data.

7. The monitoring method according to claim 6, further comprising displaying an image indicating the position of the opening.

8. The monitoring method according to claim 7, further comprising:
generating, after detecting the opening, updated three-dimensional data from a ranging result using electromagnetic waves; and
stopping displaying of the image in response to determining that the opening is not detected based on the updated three-dimensional data.

9. The monitoring method according to claim 1, further comprising masking the three-dimensional data to exclude, from the detecting, a part of the three-dimensional data corresponding to a part of the interior of the cleanroom other than a predetermined part.

10. The monitoring method according to claim 4, further comprising:
identifying, in response to detecting the opening, a position of the opening based on the three-dimensional data; and
identifying, based on a result of the comparing, a position of an object in the cleanroom that has a height higher than the reference height,
wherein the alarm is issued in a manner corresponding to a distance from the position of the object to the position of the opening.

11. The monitoring method according to claim 1, further comprising processing the three-dimensional data for visualization.

12. A monitoring apparatus for monitoring an interior of a cleanroom in which removable floor tiles are disposed on a floor, the monitoring apparatus comprising:
a data generator configured to generate three-dimensional data of the interior of the cleanroom from a ranging result using electromagnetic waves; and
circuitry configured to:
compare a height of each part of the interior of the cleanroom indicated by the three-dimensional data, with a predetermined reference height; and
detect an opening in the floor from which a floor tile has been removed, based on a result of comparing the height of each part with the reference height.

13. The monitoring apparatus according to claim 12, wherein the circuitry is further configured to determine the reference height based on reference three-dimensional data of the interior of the cleanroom generated by the data generator prior to generating the three-dimensional data.

14. The monitoring apparatus according to claim 12, wherein the circuitry is configured to detect the opening in response to determining that a part of the interior of the cleanroom has a height lower than the reference height by at least a threshold.

15. The monitoring apparatus according to claim 12, wherein the circuitry is further configured to issue an alarm in response to detecting the opening.

16. The monitoring apparatus according to claim 12, wherein the circuitry is further configured to identify, in response to detecting the opening, a position of the opening based on the three-dimensional data.

17. The monitoring apparatus according to claim 16, wherein the circuitry is further configured to display an image indicating the position of the opening.

18. The monitoring apparatus according to claim 12, wherein the circuitry is further configured to mask the three-dimensional data to exclude, from detecting the opening, a part of the three-dimensional data corresponding to a part of the interior of the cleanroom other than a predetermined part.

19. The monitoring apparatus according to claim 15, wherein the circuitry is further configured to:
identify, in response to detecting the opening, a position of the opening based on the three-dimensional data;
identify, based on a result of the comparing, a position of an object in the cleanroom that has a height higher than the reference height; and
issue the alarm in a manner corresponding to a distance from the position of the object to the position of the opening.

20. A non-transitory memory device having instructions stored thereon that, in response to execution by a processing device, cause the processing device to perform operations for monitoring an interior of a cleanroom in which removable floor tiles are disposed on a floor, the operations comprising:
generating three-dimensional data of the interior of the cleanroom from a ranging result using electromagnetic waves;
comparing a height of each part of the interior of the cleanroom indicated by the three-dimensional data, with a predetermined reference height; and
detecting an opening in the floor from which a floor tile has been removed, based on a result of the comparing.
